(19) United States
(12) Patent Application Publication
(10) Pub. No.: US 2016/0200038 A1
(43) Pub. Date: Jul. 14, 2016

(54) METHOD AND DEVICE FOR OVERMOLDING UV-CURABLE MATERIAL OVER POLYMER INSERTS

(71) Applicant: ALPHINITY, LLC, Carson City, NV (US)

(72) Inventors: Michael C. Gagne, Carson City, NV (US); Dean Richards, Simi Valley, CA (US); Steven V. Cates, Corona, CA (US)

(73) Assignee: ALPHINITY, LLC, Carson City, NV (US)

(21) Appl. No.: 14/912,693

(22) PCT Filed: Aug. 22, 2014
(86) PCT No.: PCT/US14/52383

§ 371 Date: Feb. 18, 2016

Related U.S. Application Data
(60) Provisional application No. 61/871,752, filed on Aug. 29, 2013.

(51) Int. Cl. B29C 65/70; F16L 33/34; F16L 47/32; B29C 65/00

(52) U.S. Cl. CPC B29C 65/70; B29C 66/5221; B29C 66/636; F16L 33/34; F16L 47/32; B29K 2083/00

(57) ABSTRACT

A fluid management assembly includes a connector having at least one inlet and at least one outlet and a lumen extending there between, wherein the connector comprises a plastic material. The assembly includes a first tubing portion connected to the at least one inlet at a first interface and a second tubing portion connected to the at least one outlet at a second interface. The assembly includes a polymer-based overmolding surrounding the connector, the first interface, and the second interface, wherein the polymer-based overmolding comprises a UV-curable material. In one embodiment, the polymer-based overmolding includes a UV-curable silicone or silicone-containing material.

### RELATED APPLICATION

This Application claims priority to U.S. Provisional Patent Application No. 61/871,752 filed on Aug. 29, 2013, which is hereby incorporated by reference in its entirety. Priority is claimed pursuant to 35 U.S.C. §119 and any other applicable statute(s).

### FIELD OF THE INVENTION

The field of the invention generally relates to fluid management devices and, in particular, connectors or interfaces used therein. More specifically, the invention pertains to connectors or interfaces used by pharmaceutical and biological applications or other hygienic process industries involving silicone tubing or other conduits.

### BACKGROUND OF THE INVENTION

Many commercial products are produced using chemical as well as biological processes. Pharmaceuticals, for example, are produced in commercial quantities using scaled-up reactors and other equipment. So-called biologics are drugs or other compounds that are produced or isolated from living entities such as cells or tissue. Biologics can be composed of proteins, nucleic acids, or complex combinations of these substances. They may even include living entities such as cells. In order to produce biologics on a commercial scale, sophisticated and expensive equipment is needed. In both pharmaceutical and biologics, for example, various processes need to occur before the final product is obtained. For example, in the case of biologics, cells may be grown in a growth chamber or the like and nutrients may need to be carefully modulated into the growth chamber. Waste products produced by cells may also have to be removed on a controlled basis from the fermentation chamber. As another example, biologic products produced by living cells or other organisms may need to be extracted and concentrated. This process may involve a variety of filtration and separation techniques.

Because there are a number of individual processes required to be produce the final product, various reactants, solutions, and washes are often pumped or otherwise transported to various subsystems using conduits and associated valves. These systems may be quite cumbersome and organizationally complex due to the large numbers of conduits, valves, sensors, and the like that may be needed in such systems. Not only are these systems visually complex (e.g., resembling spaghetti) they also include many components that are required to sterilized between uses to avoid cross-contamination issues. Indeed, the case of drug and biologic preparation, the Federal Food and Drug Administration (FDA) is becoming increasingly strict on cleaning, sterilization or bio-burden reduction procedures that are required for drug and pharmaceutical preparations. This is particularly of a concern because many of these products are produced in batches which would require repeated cleaning, sterilization or bio-burden reduction activities on a variety of components.

Some attempts have been made at incorporating various disposable elements into the system. For example, conduits or lines connecting various systems or elements have been made of silicone. Unfortunately, silicone tubing or conduits often have to be reinforced along their periphery to avoid the possibility of leakage through an aneurysm or the like that develops at the wall of the tubing. Reinforced silicone tubing is, however, rather expensive and is not as flexible as un-reinforced silicone.

In addition, silicone tubing often connects to other connectors or junctions (e.g., Tees, Wyes, unions, elbows) as part of the overall system. Current interfaces between silicone tubing and various connectors are deficient in a number of respects. First, current interfaces are limited in the pressure that they can handle. For example, existing connections between silicone tubing and connectors can operate at pressures at or below about 30 psi. There is a growing need to utilize higher pressures within systems because higher pressures (as well as larger tubing diameters) enables higher throughput. In addition, the interface between the silicone tubing and the connector often requires an external clamping member such as a zip tie which surrounds the junction between the silicone tubing and the inner connector. Unfortunately, the presence of these zip ties or other clamping members on the exterior tubing can lead to tears or breakages in the disposable gloves used by workers which jeopardizes the sterile environment in which these systems are typically used.

Another disadvantage of current junctions and interfaces between silicone tubing and various devices is the fact that they introduce another material that contacts the pharmaceutical or biological component that is carried through the system. While plastics and silicone have known interactions with pharmaceutical and biological components, other materials have unknown or deleterious effects on the final product. This tertiary contact with the product may jeopardize the purity and sterility of the ultimate product. For example, connectors and junctions are sometimes created using an internal mandrel. During the manufacturing process, the use of the mandrel produces flash which may have to be manually removed prior to final assembly and use. Inevitably, however, some flash may remain which can clog or otherwise disrupt the process. It also introduces a variable in the form of the overmolding or joining silicone that is now a product contact material that needs to be monitored and qualified for the manufacturer's validation documentation.

U.S. Pat. No. 5,447,341 illustrates a molded hose branch of rubber that is formed by slipping completely vulcanized rubber hose lengths with ends onto the free ends of a plastic tubing branching piece. The assembly is placed into a mold and a thermoplastic material such as a blended mixture of polyproplylene and EPDM is injected molded around the assembly so as to join the thermoplastic material to the rubber hose lengths. The problem with such a construction in connection with systems that rely on silicone, in conventional silicone molding processes, the temperature at which silicone cures would cause the inner plastic branching piece to melt. Standard platinum cured silicone may require extended temperature of around 180° C. to cross-link silicone. These high temperatures would melt or otherwise destroy the underlying plastic branching piece.

U.S. Pat. No. 6,290,265 discloses a tubing and connector assembly that includes a multi-lumen connector having at least three flexible tubes molded onto the connector. The process of making the connector and tubing assembly includes forming a first part of the connector with two tubes molded therein and then removing an internal mold member prior to molding the final connector portion and third tube in place. As noted above, in this method, an internal mandrel-type structure is used as the method uses an inner mold member and mold insert.

U.S. Pat. No. 6,432,345 illustrates a single-step method of manufacturing a silicone tube manifold. The method forms, in a single step, a silicone manifold interconnecting a plurality of silicone tubes. The method is performed by providing a silicone insert piece having a network of interior channels dimensioned the same as the silicone tube interiors. Solid non-silicone plugs are inserted into the insert piece and the ends of the silicone tubes and the resulting assembly is placed in a mold cavity. Liquid silicone is added to the mold cavity and is then heated and cured to form the desired manifold interconnecting the tubes. The manifold is then removed from the mold and a source of pressurized air is used to blow out the plugs.

U.S. Pat. No. 8,424,923 illustrates a fluid transfer assembly for transporting medicinal substances. The fluid transfer assembly includes flexible tubes and a manifold each comprising silicone. The manifold has an inner protrusion and connector portions having inner walls. Free ends of the tubes are inserted into complementary configured inner walls of the connector portions until each of the free ends abut the inner protrusion, which creates a continuous uninterrupted passageway between the inner bores of the tubes through the manifold. This patent discloses the formation of an outer capsule by using silicone rubber that is introduced into a molding assembly.

### SUMMARY OF THE INVENTION

According to one aspect of the invention, a fluid management assembly includes a connector having at least one inlet and at least one outlet and a lumen extending there between, wherein the connector comprises a plastic material. The assembly includes a first silicone tubing connected to the at least one inlet at a first interface and a second silicone tubing connected to the at least one outlet at a second interface. A silicone overmolding surrounds the connector, the first interface, and the second interface, wherein the silicone overmolding comprises a UV-curable silicone.

According to another embodiment, a method of forming a fluid management assembly includes a coupling first and second silicone tubing portions to a plastic material connector having at least one inlet and at least one outlet and a lumen extending there between, wherein the at least one inlet is coupled to the first silicone tubing portion at a first interface and wherein the at least one outlet is coupled to the second silicone tubing portion at a second interface; inserting the connector into a cavity of a mold; injecting a liquid silicone rubber into the mold cavity; and applying UV radiation to the liquid silicone rubber to cure the silicone.

In another embodiment, a fluid management assembly includes a connector having at least one inlet and at least one outlet and a lumen extending there between, wherein the connector comprises a plastic material. A first tubing is portion connected to the at least one inlet at a first interface. A second tubing portion connected to the at least one outlet at a second interface. The assembly includes a polymer-based overmolding surrounding the connector, the first interface, and the second interface, wherein the polymer-based overmolding comprises a UV-curable material.

In another embodiment, a method of forming the fluid management assembly discussed above includes coupling first and second tubing portions to the connector, wherein the at least one inlet is coupled to the first tubing portion at a first interface and wherein the at least one outlet is coupled to the second tubing portion at a second interface. The connector is inserted into a cavity of a mold and an un-cured liquid polymer is injected into the mold cavity. UV radiation is applied to the un-cured liquid polymer to cure the polymer into a solid material.

### BRIEF DESCRIPTION OF THE DRAWINGS

FIG. 1 illustrates a fluid management assembly according to one embodiment.

FIG. 2A illustrates a fluid management assembly with a connector formed as a wye.

FIG. 2B illustrates a fluid management assembly with a connector formed as a connector.

FIG. 2C illustrates a fluid management assembly with a connector formed as an elbow.

FIG. 2D illustrates another embodiment of a connector in the form of a manifold.

FIG. 2E illustrates another embodiment of a connector in the form of a reducer.

FIG. 3 illustrates a mold containing a connector and tubing segments ready to receive the liquid polymer.

FIG. 4 illustrates a fluid management assembly according to another embodiment.

### DETAILED DESCRIPTION OF THE ILLUSTRATED EMBODIMENTS

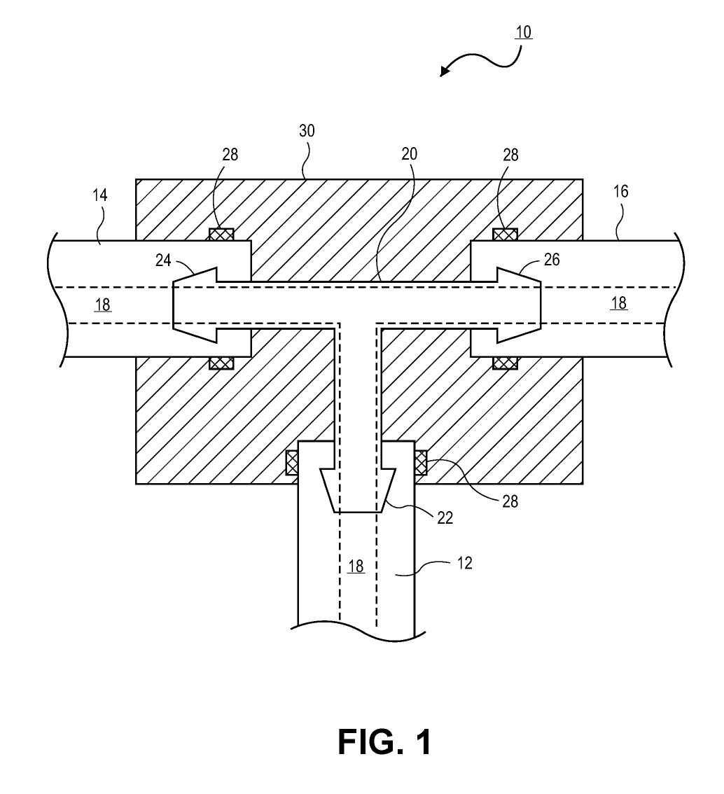

FIG. 1 illustrates a fluid management assembly 10 according to one embodiment. The fluid management assembly as illustrated in FIG. 1 includes a first tubing segment 12, a second tubing segment 14, and a third tubing segment 16. Each tubing segment 12, 14, 16 includes a lumen or passageway therein 18 for the passage of fluids. The tubing segments 12, 14, 16 may be formed from a number of materials including silicone, braided and/or reinforced silicone, a thermoplastic elastomer (TPE) or a thermoplastic rubber (TPR). The tubing segments 12, 14, 16 can have any number of dimensions but the invention is particularly suited for larger diameter tubing (e.g., between ¾ inch ID and 2 inch ID although this range is not limiting). The free ends of the tubing segments 12, 14, 16 are connected to ends of a connector 20. The connector 20 illustrated in FIG. 1 includes ends 22, 24, and 26. The ends 22, 24, 26 are preferably barbed ends as illustrated although in other embodiments the ends 22, 24, 26 may not be barbed. A frictional interface is formed where each tubing segment 12, 14, 16 joins with the respective ends 22, 24, and 26 of the connector 20.

In the embodiment of FIG. 1, one tubing segment (e.g., segment 12) may serve as an inlet while the remaining tubing segments 14, 16 may serve as outlets for fluid. As described herein, a variety of different configurations of the connector 20 are contemplated. In all the embodiments, there is at least one inlet and at least one outlet on the connector 20. Still referring to FIG. 1, clamps 28 are illustrated surrounding the tubing segments 12, 14, 16 at interface formed between the tubing segments 12, 14, 16 and the ends 22, 24, 26. The clamps 28 are optional and may increase the robustness of the fluid management assembly 10 enabling the same to operate at higher pressures. The clamps 28 may take any number of forms. For example, the clamps 28 may include hose clamps or zip ties commonly used in fluid applications.

The connector 20 may be made from a number of polymer materials. For example, the connector 20 may be made from a plastic material. Plastic materials include standard thermoplastics and polyolefins such as polyethylene (PE) and polypropylene (PP). The connector 20 may also be formed from fluoropolymers such as polyvinylidene fluoride (PVDF) or Perfluoroalkoxy (PFA), Polytetrafluoroethylene (PTFE), Polycarbonate (which may be more thermally resistant) and the like. Typically, the connector 20 is made from a polymer material that would be compromised upon exposure to high thermal temperatures like those experienced in conventional thermal curing processes.

Still referring to FIG. 1, the fluid management assembly 10 includes a polymer-based overmolding 30. The polymer-based overmolding 30 as explained in more detail below is a solid section that becomes solid after exposure to ultraviolet (UV) radiation during a curing process. The overmolding 30 covers the entirety of the connector 20 as well as the interface formed between tubing segments 12, 14, 16 and ends 22, 24, and 26. In this regard, the overmolding 30 adds additional strength to the respective interfaces formed between the tubing segments 12, 14, 16 and the ends 22, 24, and 26. This enables the fluid management assembly 10 to be very robust and can operate at very high operating pressures. For example, typical connectors are believed to operate at maximum pressures of around 25-30 psi. However, in the fluid management assembly 10 is able to operate at much higher pressures—e.g., above 50 psi or 100 psi. The presence of the optional clamps 28 can be used for applications requiring particularly high pressures.

In one aspect of the invention, the polymer-based overmolding 30 is silicone based. For example, SILOPREN available from Momentive Performance Materials Inc. (Albany, N.Y.) is a UV cured Liquid Silicone Rubber (LSR) that may be used as the overmolding 30. SILOPREN is a two-component LSR what uses a mixing ratio of 100:2. Another example of a UV cured silicone is ADDISIL available from Momentive Performance Materials Inc. (Albany, N.Y.) which offers high cure speed at room temperatures. ADDISIL silicone rubber is a two component solution that uses a mixing ratio of 100:0.5 (Rubber Base:Catalyst). The benefits of using a UV curable overmolding 30 are numerous. First, there is no heating of the materials as is required in conventional silicone curing techniques. Thus, the overmolding 30 may be formed at substantially room temperatures. If the polymer based connector 20 described herein were to be overmolded with conventional thermally-cured silicone, the connector 20 itself would melt, deform, or otherwise fail during the curing process. Here, using the UV curing process, the connector 20 remains unaffected by the curing process. Because no heating is required, the process also has low energy consumption. Further, the UV curing process uses less equipment and can increase throughput as heating up and cool-down tend to consume a considerable amount of time. Another example of a UV curable silicone is the SEMICOSIL UV product made by Wacker Chemie AG (Munich, Germany).

Standard liquid silicone rubbers are processed in molds generally at temperatures between 180 and 200° C. UV-cured LSR parts can be made with transparent molds cured by UV light as explained herein. UV curing typically occurs at ambient or slightly above ambient temperatures (e.g., 25-40° C.). For thick parts, UV curing is advantageous because the product may cross-link much more quickly than with thermal curing because the low thermal conductivity of the silicone rubber is not a factor. Another advantage of UV curing is that the curing is initiated when the light is first turned on rather than on first contact with the heated mold. This difference eliminates the problem of silicone rubber scorching. Related to this, the liquid silicone (or other polymer) can be pumped into the mold relatively slowly and at low pressures.

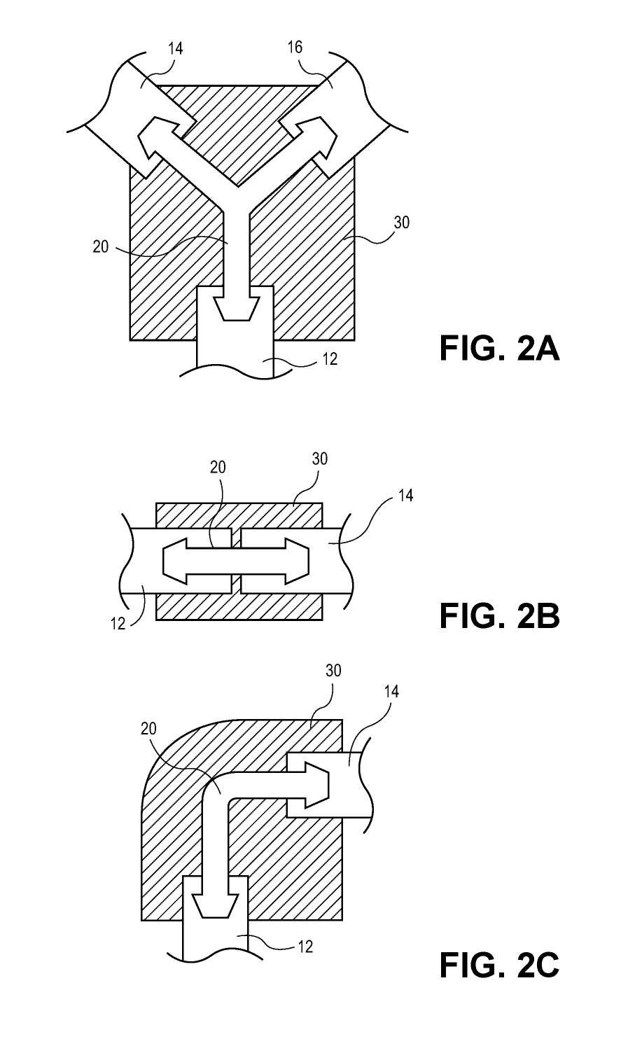

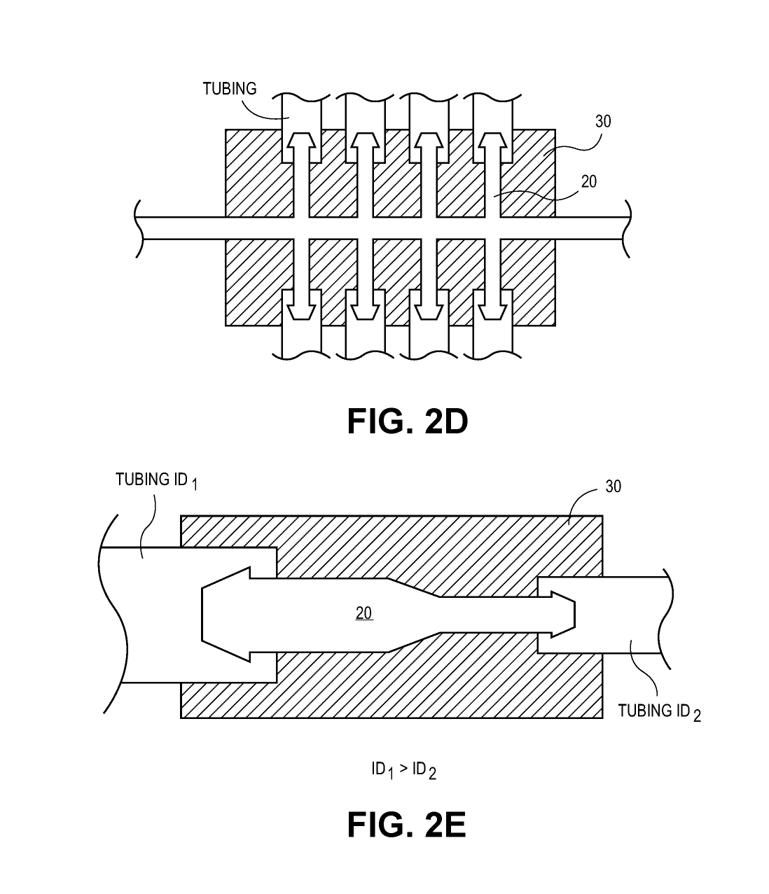

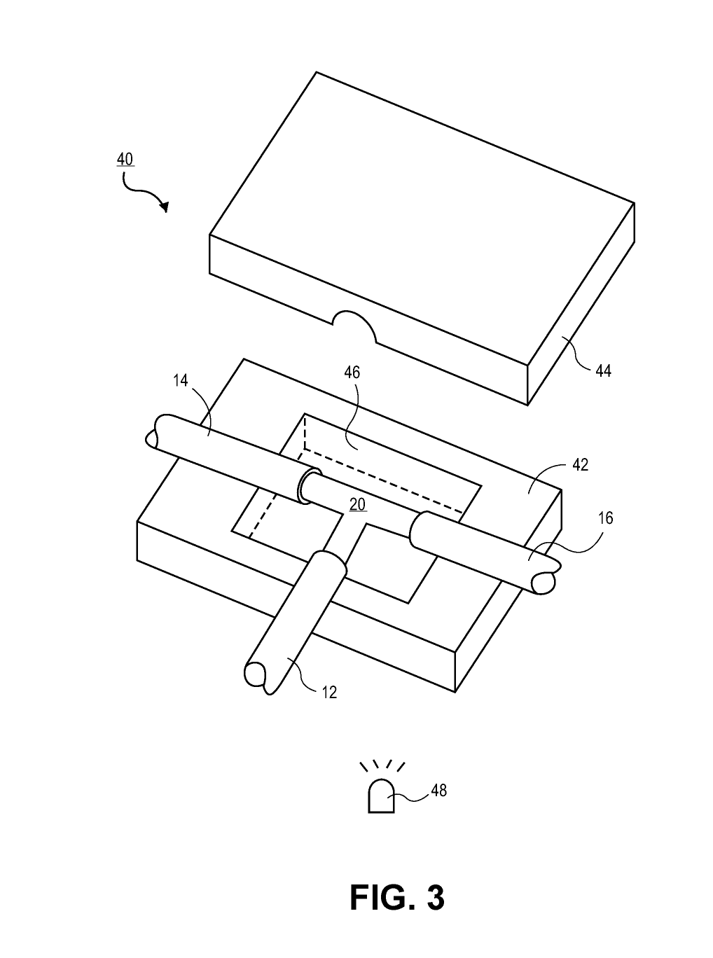

FIGS. 2A-2E illustrates various different embodiments of a fluid management assembly 10. The connector 20 may take a number of different forms and configurations. For example, the connector 20 may be a wye, tee, elbow, coupling, or connector. FIG. 2A illustrates a connector 20 in the form of a wye (or “Y”). FIG. 2B illustrates the connector 20 in the form of a coupler. FIG. 2C illustrates a connector in the form of an elbow. FIG. 2D illustrates another embodiment of a connector 20 in the form of a manifold. FIG. 2E illustrates another embodiment of a connector 20 in the form of a reducer. Here, the connector 20 is able to couple tubes having different internal diameters (ID). Other configurations may also be used for the connector 20. For example, the connector 20 may be a union member, or multi inlet/outlet member. The connector 20, in a general sense, includes at least one inlet and at least one outlet.

FIG. 3 illustrates a mold 40 used in connection with the formation of the fluid management assembly 10. The mold 40 illustrated in FIG. 3 includes first and second halves 42, 44. A cavity 46 is formed in the mold as illustrated in FIG. 3 that is used to receive the polymer-based overmolding 30 in liquid form. The mold 40 should be transparent to UV radiation and stable during the curing process. In one aspect, the mold 40 is made from quartz glass or polymethyl methacrylate (PMMA). A UV light source 48 is also provided as seen in FIG. 3. The UV light source 48 may be provided external to the mold 40 or, in other embodiments, may be integrated into a portion of the mold 40 itself. The UV light source 48 may include gas discharge lamps (microwave or electrode systems) or LED lamps. LED lamps may be preferred because they generate less heat and may result in molds 40 having a longer life. The molds 40 may be made using conventional mold-making processes. The molds 40 can also be made using three-dimensional printing technologies such that designs can be rapidly and cheaply turned into products.

In one aspect of the invention, a method of forming a fluid management assembly 10 includes coupling first and second silicone tubing portions (e.g., 12, 14, 16) to a connector 20 having at least one inlet and at least one outlet and a lumen extending there between, wherein the at least one inlet is coupled to the first silicone tubing portion at a first interface and wherein the at least one outlet is coupled to the second silicone tubing portion at a second interface. The connector 20 is inserted into a cavity of a mold 40. Alternatively, the silicone tubing portions 12, 14, 16 may be connected to the connecter 20 after it has been inserted into the mold 40. A liquid silicone rubber is injected into the mold cavity 46 and surrounds the connector 20 and connected tubing portions 12, 14, 16. UV radiation from the UV light source 48 is applied to the liquid silicone rubber to cure the silicone. While this embodiment is described in the context of a UV-curable silicone, it should be understood that other UV-curable polymers are also contemplated.

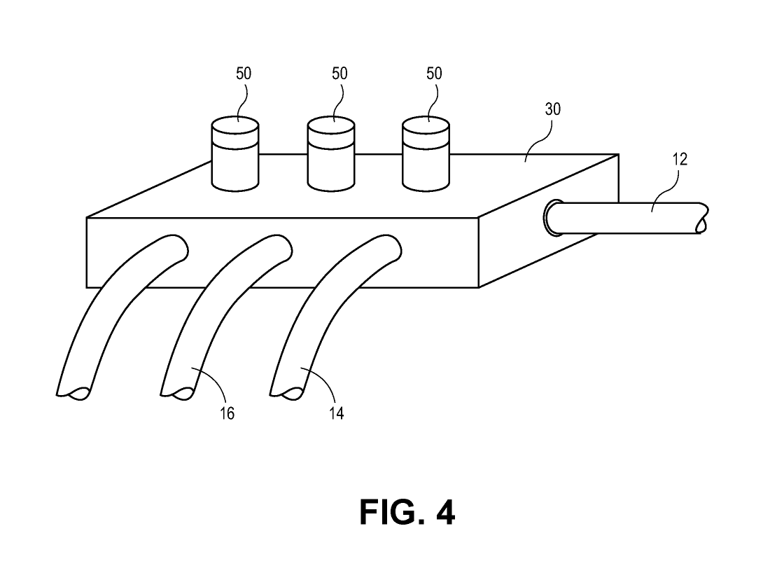

FIG. 4 illustrates another embodiment of a fluid management assembly 10. In this embodiment, the overmolding 30 encapsulates an interior connector like the manifold of FIG. 2D that is connected to varying tubing segments. In this embodiment, valves 50 are provided on the overmolding 30 and selectively engage or pinch portions of the interior connector to valve fluid to one or more particular tubing segments. The valves 50 may be manual bonnet-style valves or the valves may be automatically actuated valves (e.g., pneumatic or servo-based). The fluid management assembly 10 of FIG. 10 has particular robustness and can operate at high pressures.

It should be understood that the fluid management assembly 10 is designed to be disposable. Systems that are disposable or incorporate disposable elements are advantageous because they avoid the need for cleaning-in-place (CIP) cleaning, sanitization, or re-sterilization. A major advantage of the embodiments described herein is that the product contained within the system only contacts two components—the interior surface of the tubing 12, 14, 16 as well as the interior surface of the connector 20. The product does not contact any third substance such as a mandrel or flashing material left from some other component used during the manufacturing process. The fluid management assembly 10 is also scalable meaning that large diameter tubes can be used. Further, the fluid management assembly 10 is very robust and able to handle large pressures.

In another alternative embodiment of the invention, a fluid management assembly may be made using a mandrel using one or more techniques described above, for example, as noted in U.S. Pat. No. 6,290,265, however the mandrel is used in conjunction with a UV-curable overmolding as described herein. In such an alternative embodiment, there is no need for a separate connector.

While embodiments of the present invention have been shown and described, various modifications may be made without departing from the scope of the present invention. The invention, therefore, should not be limited, except to the following claims, and their equivalents.

1. A fluid management assembly comprising:
a connector having at least one inlet and at least one outlet and a lumen extending there between, wherein the connector comprises a plastic material;
a first silicone tubing connected to the at least one inlet at a first interface;
a second silicone tubing connected to the at least one outlet at a second interface;
a silicone overmolding surrounding the connector, the first interface, and the second interface, wherein the silicone overmolding comprises a UV-curable silicone.

2. The fluid management assembly of claim 1, wherein the connector comprises a Tee connector.

3. The fluid management assembly of claim 1, wherein the connector comprises a Wye connector.

4. The fluid management assembly of claim 1, wherein the connector comprises a union.

5. The fluid management assembly of claim 1, wherein the connector comprises a coupler.

6. The fluid management assembly of claim 1, wherein the connector comprises an elbow.

7. The fluid management assembly of claim 1, wherein the connector comprises a reducer.

8. The fluid management assembly of claim 1, further comprising a clamp surrounding the first silicone tubing at the first interface and another clamp surrounding the second silicone tubing at the second interface.

9. (canceled)

10. The fluid management assembly of claim 1, wherein the burst pressure of the assembly exceeds 50 psi.

11. The fluid management assembly of claim 1, wherein the burst pressure of the assembly exceeds 100 psi.

12. The fluid management assembly of claim 1, wherein the at least one inlet and the at least one outlet comprise barbed ends.

13. A method of forming a fluid management assembly comprising:
coupling first and second silicone tubing portions to a plastic material connector having at least one inlet and at least one outlet and a lumen extending there between, wherein the at least one inlet is coupled to the first silicone tubing portion at a first interface and wherein the at least one outlet is coupled to the second silicone tubing portion at a second interface;
inserting the connector into a cavity of a mold;
injecting a liquid silicone rubber into the mold cavity; and
applying UV radiation to the liquid silicone rubber to cure the silicone.

14. The method of claim 13, wherein the liquid silicone rubber is cured at substantially room temperature.

15. The method of claim 13, wherein the connector is inserted into the cavity of the mold prior to coupling the first and second silicone tubing portions to the plastic material connector.

16. The method of claim 13, wherein the connector is inserted into the cavity of the mold after coupling the first and second silicone tubing portions to the plastic material connector.

17. The method of claim 13, further comprising securing a clamp around the first silicone tubing portion at the first interface.

18. The method of claim 13, further comprising securing a clamp around the second silicone tubing portion at the second interface.

19. A fluid management assembly comprising:
a connector having at least one inlet and at least one outlet and a lumen extending there between, wherein the connector comprises a plastic material;
a first tubing portion connected to the at least one inlet at a first interface;
a second tubing portion connected to the at least one outlet at a second interface;
a polymer-based overmolding surrounding the connector, the first interface, and the second interface, wherein the polymer-based overmolding comprises a UV-curable material.

20. A method of forming the fluid management assembly of claim 19 comprising:
coupling first and second tubing portions to the connector, wherein the at least one inlet is coupled to the first tubing portion at a first interface and wherein the at least one outlet is coupled to the second tubing portion at a second interface;
inserting the connector into a cavity of a mold;
injecting an un-cured liquid polymer into the mold cavity; and
applying UV radiation to the un-cured liquid polymer to cure the polymer into a solid material.

21. The fluid management assembly of claim 19, wherein the polymer-based overmolding comprises silicone.
